(19) United States
(12) Patent Application Publication
(10) Pub. No.: US 2019/0147793 A1
(43) Pub. Date: May 16, 2019

(54) PULSE-WIDTH-MODULATION CONTROL OF MICRO LED

(71) Applicant: Facebook Technologies, LLC, Menlo Park, CA (US)

(72) Inventor: Gareth John Valentine, York (GB)

(21) Appl. No.: 15/814,341

(22) Filed: Nov. 15, 2017

(51) Int. Cl. G09G 3/32

(52) U.S. Cl. CPC G09G 3/32; G09G 2320/064; G09G 2310/08

(57) ABSTRACT

Embodiments relate to a micro light-emitting-diode (mLED) cell that includes a mLED and a controller. The controller receives a brightness data signal and generates a driving signal corresponding to the brightness data signal. The controller is coupled to the mLED for providing the driving signal that turns on the mLED for first times and turns off the mLED for second times for a duration of a cycle. The driving signal causes a current density in mLED to be above a threshold value when the mLED is turned on.

### BACKGROUND OF THE INVENTION

### 1. Field of the Disclosure

The present disclosure relates to controlling the brightness of micro light emitting diodes (mLEDs) and more specifically to using a digital pulse-width-modulation (PWM) control scheme for controlling the brightness of mLEDs.

### 2. Description of the Related Art

Micro light-emitting diode (mLED) display are an emerging flat panel display technology that includes microscopic light-emitting diodes (LEDs) for displaying images. Compared to liquid crystal display (LCD) technology, mLED display devices offer improved contrast, faster response time, and lower energy consumption.

mLEDs are self-emitting elements that generate light in response to a forward bias current that is provided to the diode. The amount of light emitted by the mLED increases as the amount of current supplied to the mLED increases. In some implementations, mLEDs are driven using a voltage controlled current source which generates a driving current that increases with the increase in the voltage level of a voltage signal. The voltage signal may in turn be generated based on a data signal that specifies the desired brightness of the mLED.

### SUMMARY

Embodiments relate to a micro light-emitting-diode (mLED) cell that includes a mLED and a controller. The controller receives a brightness data signal and generates a driving signal corresponding to the brightness data signal. The controller is coupled to the mLED for providing the driving signal that turns on the mLED for first times and turns off the mLED for second times for a duration of a cycle. The driving signal causes a current density in mLED to be above a threshold value when the mLED is turned on.

Other embodiments relate to a micro light-emitting-diode (mLED) cell that includes a controller, a current source, and a mLED. The controller generates a driving signal having a set amplitude and a duty cycle proportional to a brightness data signal. The current source is coupled to an output of the controller and generates a driving current based on the driving signal generated by the controller. The average amplitude of the driving current is proportional to the brightness data signal. The mLED is coupled to the current source and emits light with an average brightness that is proportional to the driving current.

Other embodiments relate to a mLED cell that includes a memory, multiple AND gates, a current source, and a mLED. The memory includes multiple memory cells and multiple memory output, each memory output corresponding to an output of a memory cell. The memory stores a brightness data value. Each AND gate is coupled to a memory output and a periodic pulse signal. The current source is coupled to the output of each of the AND gates and generates a driving current based on the outputs of each of the AND gates. The mLED is coupled to the current source and emits light with an average brightness that is proportional to the driving current.

In one or more embodiments, the memory of the mLED cell includes one memory cell for each bit of the brightness data value. Furthermore, the mLED cell includes circuitry to implement one AND gate logic function for each bit of the brightness data value. In this embodiment, the output of one memory cell is coupled to an input of an AND gate and an input of a next memory cell. The mLED cell further receives multiple periodic pulse signals. Each periodic pulse signal coupled to an input of an AND gate.

### BRIEF DESCRIPTION OF THE DRAWINGS

The teachings of the embodiments can be readily understood by considering the following detailed description in conjunction with the accompanying drawings.

FIG. 1A illustrates a graph showing the internal quantum efficiency with respect to the current density for a conventional LED and a micro LED (mLED).

FIG. 1B illustrates a timing diagram when driving an LED with a constant current.

FIG. 1C illustrates a timing diagram for driving an mLED, according to one embodiment.

FIG. 2A illustrates a block diagram of a mLED display panel, according to one embodiment.

FIG. 2B illustrates a block diagram of a mLED cell, according to one embodiment.

FIG. 3A illustrates a circuit diagram of a mLED cell, according to one embodiment.

FIG. 3B illustrates a detailed diagram of the memory of the mLED cell of FIG. 3A, according to one embodiment.

FIG. 4A illustrates a timing diagram for the waveform of one cycle of pulse signals P₁ through P₄, according to one embodiment.

FIG. 4B illustrates a timing diagram of several PWM signals for different data inputs, according to one embodiment.

FIG. 5 illustrates a circuit diagram of a mLED cell including multiple memories, according to one embodiment.

FIG. 6 illustrates a flow diagram of a method for operating a mLED cell, according to one embodiment.

### DETAILED DESCRIPTION OF EMBODIMENTS

The Figures (FIG.) and the following description relate to preferred embodiments by way of illustration only. It should be noted that from the following discussion, alternative embodiments of the structures and methods disclosed herein will be readily recognized as viable alternatives that may be employed without departing from the principles of the embodiments.

Reference will now be made in detail to several embodiments, examples of which are illustrated in the accompanying figures. It is noted that wherever practicable, similar or like reference numbers may be used in the figures and may indicate similar or like functionality. The figures depict embodiments for purposes of illustration only.

Embodiments relate to a control scheme for controlling the brightness of a micro light-emitting-diode (mLED or μLED) while increasing the efficiency of the mLED by using a digital pulse-width-modulation (PWM) control scheme. During on-times of the PWM scheme, the current density in mLED exceeds a threshold level corresponding to an internal quantum efficiency (IQE) that is higher than a threshold efficiency. The current density of the mLED during the on-times of the PWM is higher than the current density of conventional macro LEDs. The off-times of the PWM scheme is controlled so that the average brightness of the mLED reaches the desired level.

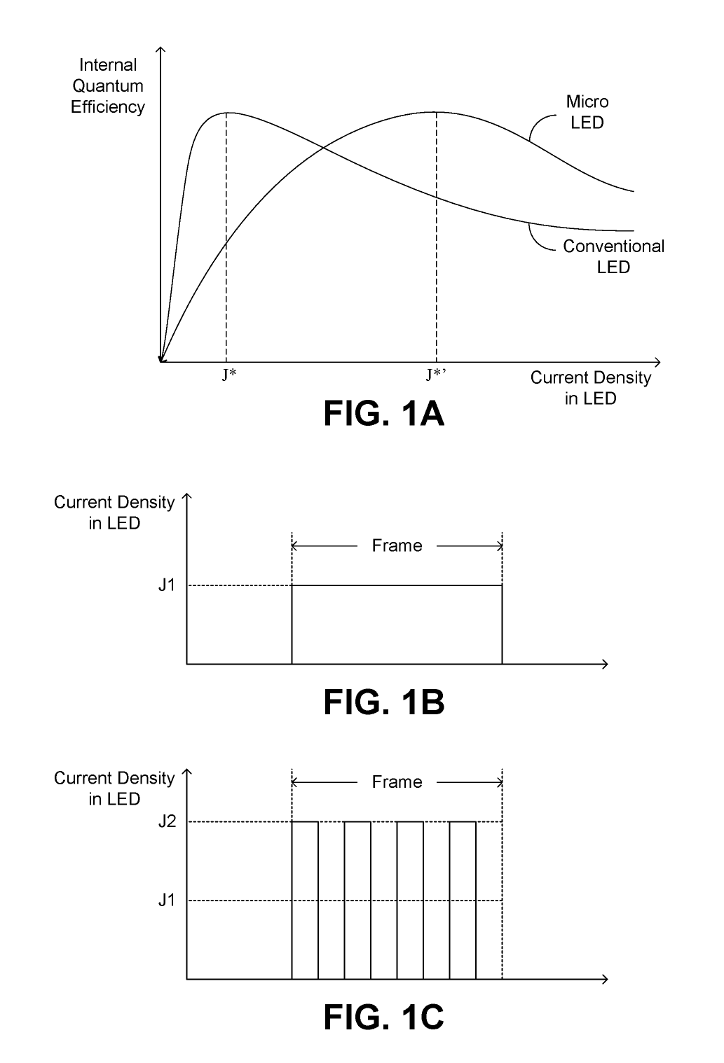

The internal quantum efficiency (IQE) of light-emitting-diodes (LEDs) changes as a function of the current density in the LED. FIG. 1A illustrates a graph showing the IQE with respect to the current density for a conventional macro LED and a micro LED (mLED). As shown in FIG. 1A, the conventional LEDs reach a peak IQE at a lower current density J* compared to the peak IQE J*′ of mLEDs. As such, conventional LEDs quickly reach an efficient light generation value, even for low current density values. In contrast, mLEDs may have poor IQE when operated at low current density values. That is, since the brightness of a mLED is proportional to the current density used to drive the mLED, compared to conventional LEDs, mLEDs are inefficient at low luminance values if driven at constant current.

FIG. 1B illustrates a timing diagram when driving an LED with a constant current. Using the driving scheme of FIG. 1B, the mLED is driven with a current J1 that is related to the desired brightness of the mLED. The current J1 is then supplied to the mLED through out the duration of a cycle (e.g., 1/60^{th} of a second). As such, the current used to drive the mLED will vary based on the desired brightness. As such, the IQE of the mLED will also vary based on the desired brightness of the mLED. As the brightness of the mLED drops, the current density in mLED drops further from J*′, causing a decrease in the IQE of the mLED. Furthermore, since the mLED is constantly being driven, and thus, emitting light, the mLED may not have time to cool down.

FIG. 1C illustrates a timing diagram for driving a mLED, according to one embodiment. Using the driving scheme of FIG. 1C, the mLED is driven with a preset current J2. The perceived brightness of the mLED is then controlled by the amount of time the mLED is driven. That is, if a lower brightness is desired, the mLED is driven during a shorter amount of time within one cycle, and if a higher brightness is desired, the mLED is driven during a longer amount of time within one cycle. In the example of FIG. 1C, since the mLED is driven with the current J2 for half of the duration of the cycle, the perceived brightness of the mLED will be half of the brightness of the mLED when the mLED is driven with current J2. Since during the period of time the mLED is being driven, the mLED is supplied the same preset current where the current density in the mLED is above a threshold value J_{TH} closer to J*′ (see FIG. 1A), the IQE of the mLED can be better controlled. That is, the current J2 may be selected to so that the mLED operates with current density closer to J*′ and achieving a higher IQE.

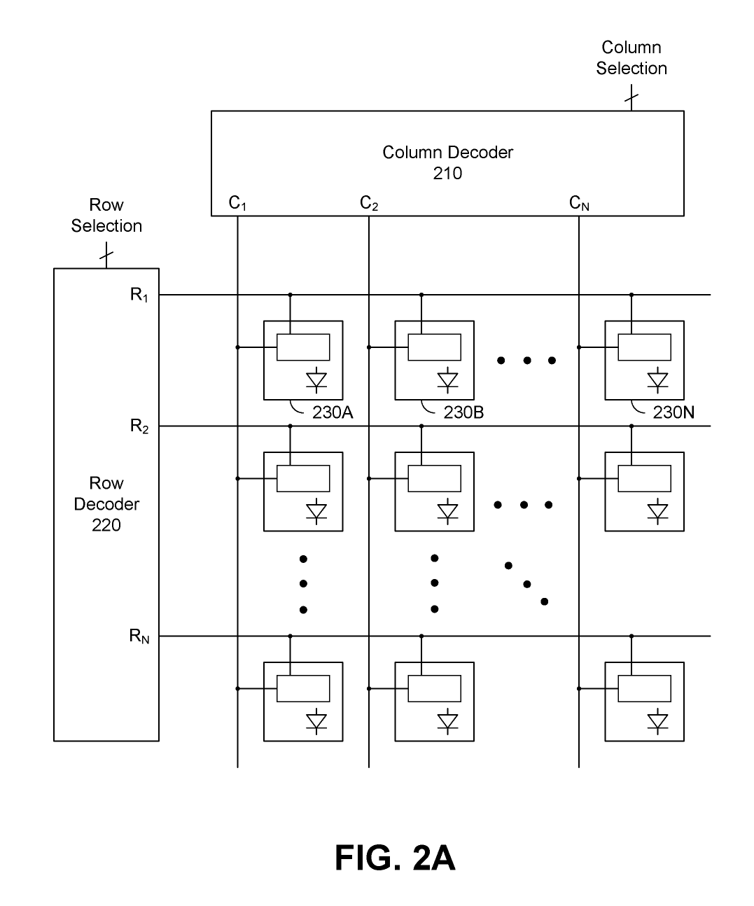

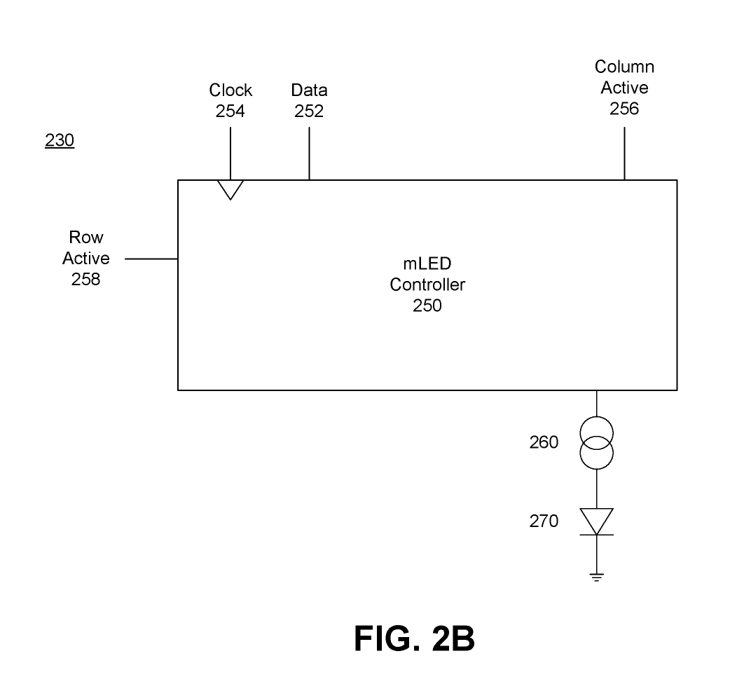

FIG. 2A illustrates a block diagram of a mLED display panel, according to one embodiment. The mLED display panel may include, among other components, a column decoder 210, a row decoder 220, and multiple mLED cells 230. The column decoder 210 selects or asserts one column of mLED cells of the display panel based on a column selection signal. In one embodiment, the column selection signal is generated by an n-bit counter. In this embodiment, the column selection decoder may be an n to 2ⁿ decoder.

The row decoder 220 selects or asserts one row of mLED cells of the display panel based on a row selection signal. In some embodiments, the row selection signal is generated by an m-bit counter. In this embodiment, the row selection decoder may be an m to 2^{m} decoder.

The multiple mLED cells 230 are arranged in a grid pattern. In some embodiments, the mLED cells are arranged in other patterns, such as, a circular pattern, an oval pattern. Each mLED cell of the display panel is coupled to one output of the column decoder 210 and one output of the row decoder 220. As such, a specific mLED cell may be addressed by asserting a specific output of the column decoder 210 and a specific output of the row decoder 220. For instance, mLED cell 230A is addressed by asserting column decoder output C₁ and row decoder output R₁, mLED cell 230B is addressed by asserting column decoder output C₂ and row decoder output R₁, mLED cell 230N is addressed by asserting column decoder output C_{N} and row decoder output R₁, and so forth.

To increase the efficiency of the mLED display panel, the mLEDs are driven with a current density that is larger than a threshold value. In some embodiments, the threshold value is 300 A/cm². If a low luminance value is desired (e.g, in a dark scene of a video), instead of driving the mLED with a lower current density, the mLED is driven for a shorter amount of time, or using shorter emission bursts using the PWM scheme as described above with reference to FIG. 1C.

FIG. 2B illustrates a block diagram of a mLED cell 230, according to one embodiment. The mLED cell 230 includes a mLED controller 250, a current source 260, and a mLED 270. The mLED controller 250 receives as an input a data signal 252, a column active signal 256, a row active signal 258, and a clock 254. The mLED controller 250 stores the data signal 252 that is synchronized to the clock 254 when the column active signal 256 and the row active signal 258 are both asserted. In some embodiments, the mLED controller 250 is configured to receive a single active signal and stores the data signal 252 when the active signal is asserted. The mLED controller 250 then generates a driving signal based on the stored data signal. The driving signal generated by the mLED controller 250 has a set voltage amplitude and a duty cycle that is based on the value of the data signal. In some embodiments, the duty cycle of the driving signal increases as the value of the data signal 252 increases. In one embodiment, the duty cycle of the driving signal is proportional to the value of the data signal 252.

The current source 260 receives the driving signal and generates a driving current for driving the mLED 270. In some embodiments, the current source 260 includes a driving transistor that turns on or off based on the driving signal received from the mLED controller 250. In this embodiment, a gate terminal of the driving transistor is controlled by the driving signal, a drain terminal of the driving transistor is coupled to a power supply voltage, and the source terminal of the driving transistor is coupled to the mLED. In some embodiments, the amplitude of the driving current is chosen so that the current density of mLED is equal or substantially equal to J*′. In other embodiments, the amplitude of the driving signal is chosen so that the current density of the mLED is greater than J*′. The mLED 270 then receives the driving current and emits light accordingly.

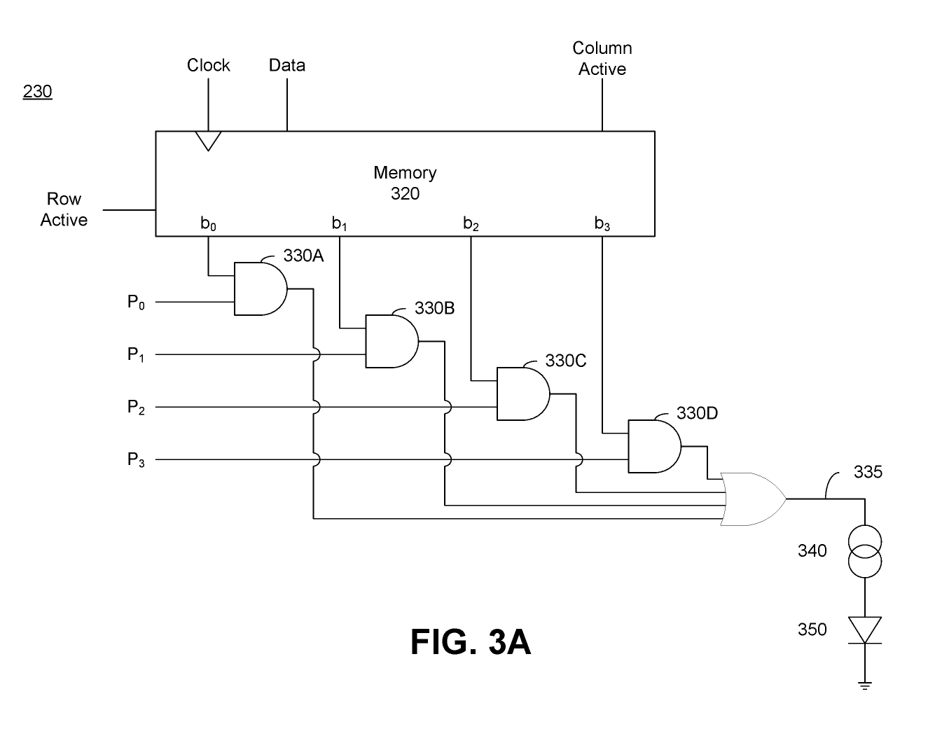

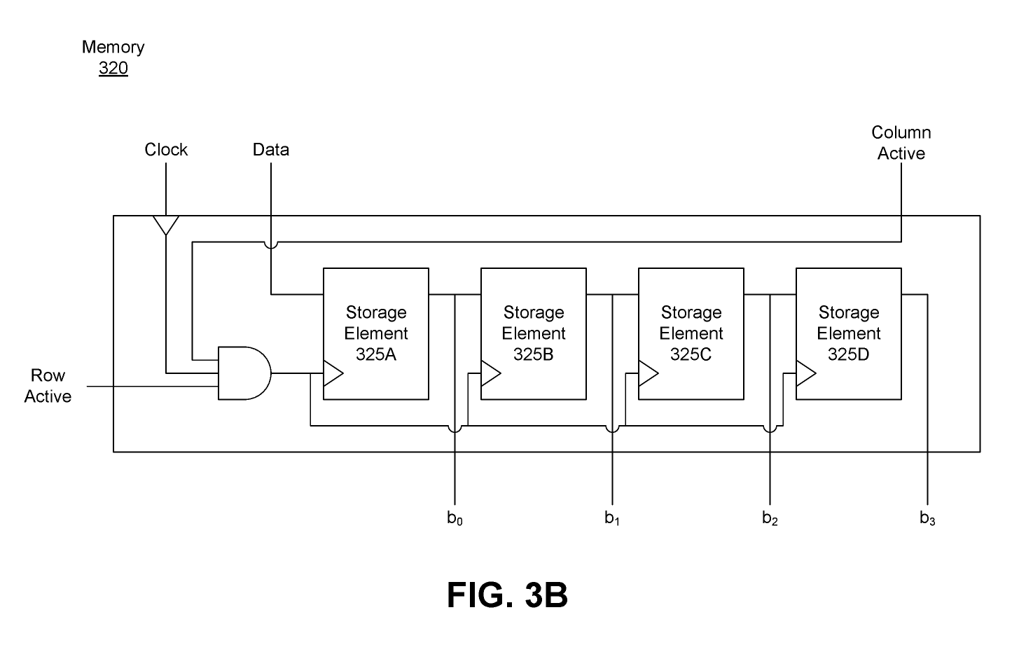

FIG. 3A illustrates a circuit diagram of a mLED cell 230, according to one embodiment. mLED 230 may include, among other components, a memory 320, multiple AND gates 330A through 330D, a current source 340 and a mLED 350. As used herein, an AND gate is a logic gate that receives at least two inputs and produces one output. In some embodiments, the AND gate only has one of a pull up network or a pull down network. For instance, the AND gate may have a pull up network that sets a high level output when both inputs are high, but has a floating output (e.g., a high impedance output) when one of the inputs are low. In the embodiments where the AND gates only have one of a pull up network or a pull down network, an OR gate that combines the output of the AND gates may be obviated. The output of the AND gate has a high level (HI) when the voltage level for both outputs are above a threshold value, and has a low level (LO) when the voltage level of at least one input is below the threshold value. The memory 320 includes storage elements (not shown) that stores a digital value indicative of a desired brightness for the mLED 350 of the mLED cell 230. The memory 320 of FIG. 3 stores four-bit values that are indicative of the desired brightness of the mLED 350. In some embodiments, memory 320 may larger values (i.e., values with deeper bit depth), such as 8-bit values or 10-bit values. The memory 320 further includes multiple outputs. In some embodiments, the memory 320 includes the same number of outputs as the bit depth of the value stored by the storage elements of the memory 320.

FIG. 3B illustrates a detailed diagram of the memory 320, according to one embodiment. The memory 320 includes multiple storage elements 320. In the embodiment of FIG. 3B, the memory 320 includes four storage elements, and thus, stores a 4-bit value. As such, a mLED cell including the memory 320 of FIG. 3B may have a brightness depth of 4-bits (i.e., 16 different levels of brightness). In other embodiments, the memory 320 may include more storage elements to increase the brightness depth of the mLED cell. For instance, a mLED cell with a brightness depth of 8-bits may include a memory 320 with 8 storage elements. In some embodiments, the memory 320 is dynamic in nature with simplified circuitry since the information stored in the memory 320 is only stored for the duration of one frame period.

The memory 320 of FIG. 3B further includes four outputs b₀, b₁, b₂, and b₃. Each of the outputs bo through b₃ corresponds to the output of a storage element 325. That is, output b₀ corresponds to the output of storage element 325A, output b₁ corresponds to the output of storage element 325B, output b₂ corresponds to the output of storage element 325C, and output b₃ corresponds to the output storage element 325D. In embodiments with larger bit depth, memory 320 includes more outputs, each output corresponding to one bit of the value stored by the storage elements 325.

The memory 320 further includes a data input to serially input the value to be stored in the storage elements 325. In some embodiments, the memory instead includes multiple data inputs to provide the value to be stored in the storage elements 325 in parallel. The memory 325 further includes a clock input, a column active input, and a row active input. The memory 320 stores the value provided through the data input when the column active input and the row active input are both asserted and a clock signal is provided through the clock input. In some embodiments, the storage elements store data on a positive edge of the clock signal. In other embodiments, the storage elements store data on a negative edge of the clock signal. In the embodiment of FIG. 3B the clock input, the column active input and the row active input are combined using an AND gate. Thus, the clock signal provided through the clock input is only propagated to the storage elements when the column active input and the row active inputs are both asserted.

Referring back to FIG. 3A, each output of the memory 320 is coupled to an AND gate 330. Each gate 330 is further coupled to a pulse signal P. That is, AND gate 330A is coupled to memory output bo and pulse signal P₀, AND gate 330B is coupled to memory output b₁ and pulse signal P₁, AND gate 330C is coupled to memory output b₂ and pulse signal P₂, and AND gate 330D is coupled to memory output b₃ and pulse signal P₃. mLED cells with larger brightness depth levels may include additional AND gates 330 and may receive additional pulse signals P.

The AND gates 330 shown in FIG. 3A are logic gates with only pull up networks. That is, instead of having pull down networks, the AND gates 330 have a high impedance output when one of the inputs have a low level.

In some embodiments, the AND functionality is incorporated directly in the memory cell. That is, the output of each storage element 325 has a high impedance output unless an “output select” line of the storage element 325 is addressed. In this embodiment, the pulse signals P₀ through P₃ are provided to the “output select” line of respective storage elements 325A thorough 325D.

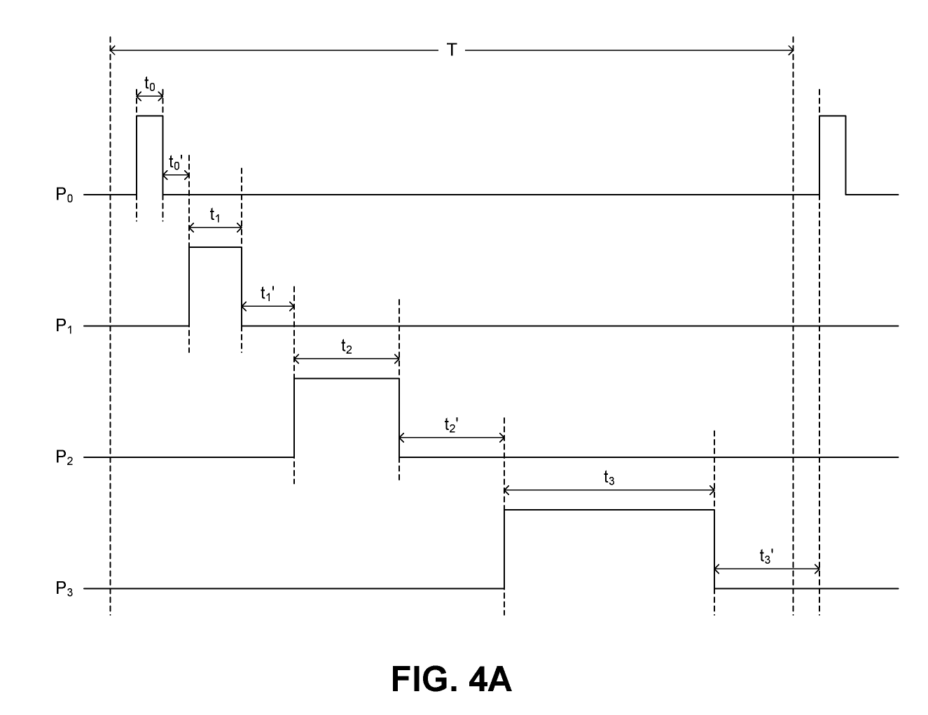

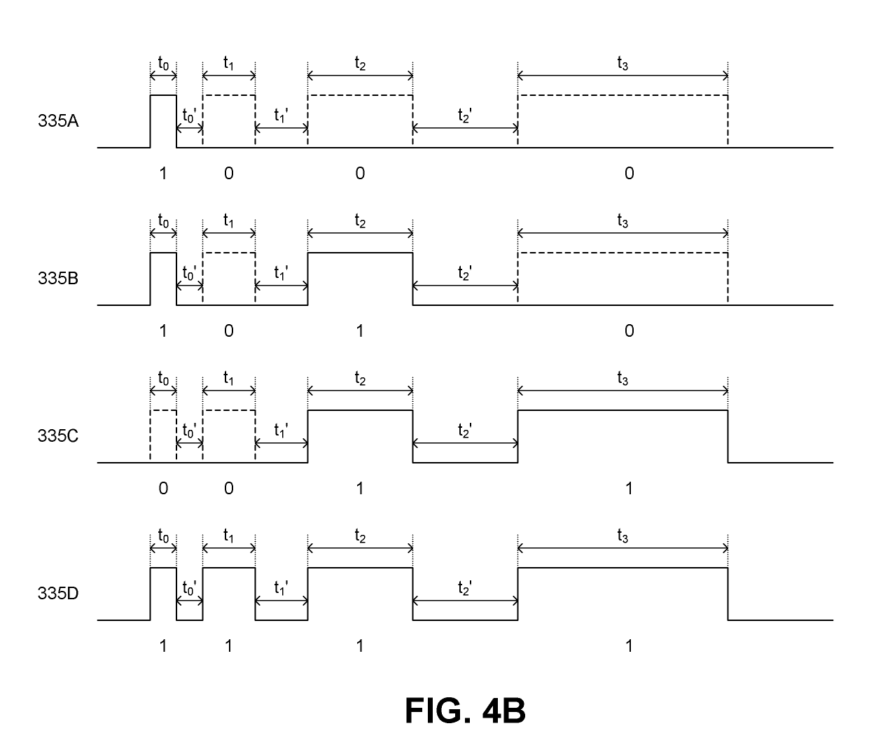

FIG. 4A illustrates a timing diagram for the waveform of one cycle of pulse signals P₀ through P₃, according to one embodiment. In the timing diagram of FIG. 4A, the horizontal axis represents time, and the vertical axis represents voltage of the pulse signals. The pulses of pulse signal P₀have a duration of t₀. That is, the time between the rising edge of pulse signal P₀ and the falling edge of pulse signal P₀ is equal to t₀. The pulses of pulse signal P₁ have a duration of t₁ and starts after a delay of t₀′ after the falling edge of pulse signal P₀. That is, the time between the raising edge of pulse signal P₁ and the falling edge of pulse signal P₁ is equal to t₁, and the time between the falling edge of pulse signal P₀ and the rising edge of pulse signal P₁ is t₀′. The duration t₁ of pulse signal P₁ is two times the duration to of pulse signal P₀. The pulses of pulse signal P₂ have a duration of t₂ and starts after a delay of t₁′ after the falling edge of pulse signal P₁. That is, the time between the raising edge of pulse signal P₂ and the falling edge of pulse signal P₂ is equal to t₂, and the time between the falling edge of pulse signal P₁ and the rising edge of pulse signal P₂ is t₁′ The duration t₂ of pulse signal P₂ is two times the duration t₁ of pulse signal P₁, or four times the duration t₀ of pulse signal P₀. The pulses of pulse single P₃ have a duration of t₃ and starts after a delay of t₂′ after the falling edge of pulse signal P₂. That is, the time between the raising edge of pulse signal P₃ and the falling edge of pulse signal P₃ is equal to t₃, and the time between the falling edge of pulse signal P₂ and the rising edge of pulse signal P₃ is t₂′. The duration t₃ of pulse single P₃ is two times the duration t₀ of pulse signal P₂, or eight times the duration to of pulse signal P₀. Furthermore, the time between falling edge of pulse signal P₃ and the rising edge of a next period of pulse signal P₀ is t₃′ Each of the pulse signals P₀ through P₃ are repeated every period T.

In one example, for a refresh rate of 90 Hz (i.e., a frequency of 90 Hz), the period T is about 11.1 ms. That is, t₀+t′₀+t₁+t′₁+t₂+t′₂+t₃+t′₃=11.1 ms. For a max PWM on/off ratio of 1:20, the maximum on time within the 11 ms window is 555.6 μs. That is, t₀+t₁+t₂+t₃=555.6 μs. As such, to is approximately 37 μs. As such, t₁ is approximately 74.1 μs, t₂ is approximately 0.148 ms, and t₃ is approximately 0.296 ms. In the embodiments where the brightness depth is different than 4 bits, t₀ may be calculate as:

$${t}_{0} = \frac{1}{refresh\_rate} \times ( PWM\_ratio ) \times \frac{1}{{2}^{n} - 1}$$

where refresh_rate is the refresh rate of the display panel (e.g., 90 Hz), PWM_ratio is the max PWM on/off ratio (e.g., 1:20), and n is the brightness depth of the mLED cell (e.g., 8 for 8-bit brightness signals).

In some embodiments, times t₀′, t₁′ t₂′, and t₃′ have the same length. In other embodiments, time t₀′ is proportional to time t₀, time t₁′ is proportional to time t₁, time t₂′ is proportional to time t₂, and time t₃′ is proportional to time t₃. This may account for a longer cool down time of the mLED due to a longer on time of the pulse signals.

In some embodiments, pulses P₀ through P₃ are generated by a chain of D-type flip-flops, each flip-flop stage performing a clock division by 2 function. In another embodiment, the pulses P₀ through P₃ are generated using a look-up-table that contains 1 bit pulse shapes corresponding to the relevant times tₙ and tₙ′. The look-up-table may be hardcoded or user programmed in a reprogrammable memory. In yet another embodiment, pulses P₀ through P₃ are generated using two clocks, one controlling the tₙ periods and the second the tₙ′ periods. In this embodiment, the control switching between the clocks is based on the state of the output. That is, a first clock is in control when the output is low and a second clock is in control when the output is high.

Referring back to FIG. 3A, the outputs of the AND gates 330 are combined to form digital PWM signal 335 and provided as an input to current source 340. FIG. 4B illustrates a timing diagram of several PWM signals for different data inputs, according to one embodiment. Digital PWM signal 335A corresponds to a data input of 0001. As such, digital PWM signal 335A is only in the ON state when pulse signal P₀ is active. Digital PWM signal 335B corresponds to a data input of 0101, and thus, is only in the ON state when pulse signals P₀ and P₂ are active. Digital PWM signal 335C corresponds to data input 1100, and thus, is only in the ON state when pulse signals P₂ and P₃ are active. Digital PWM signal 335D corresponds to data input 1111, and thus, is in the ON state when pulse signals P₀, P₁, P₂, and P₃ are active.

Referring back to FIG. 3A, the current source 340 generates a driving current signal based on the digital PWM signal and the driving current is provided to the mLED for driving the mLED. In some embodiments, the current source 340 includes a transistor that turns on and off based on the digital PWM signal. That is, the transistor of the current source 340 conducts current from a supply voltage when the digital PWM signal is in the ON state and blocks current from passing when the digital PWM signal is in the OFF state.

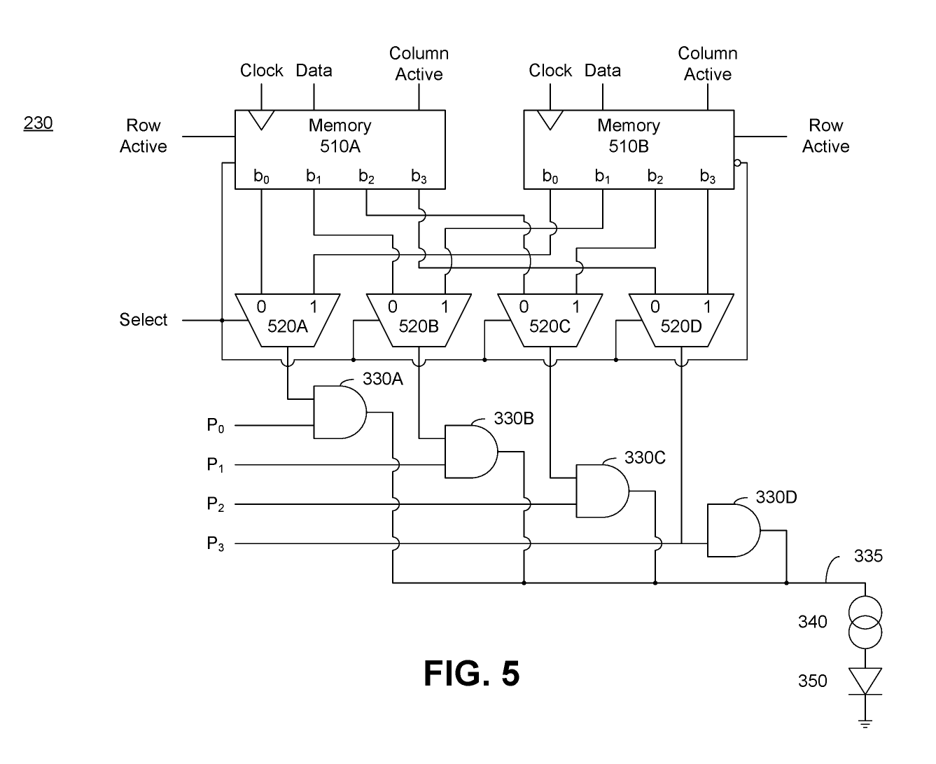

FIG. 5 illustrates a circuit diagram of a mLED cell 230 including multiple memories, according to one embodiment. The mLED cell 230 of FIG. 5 includes two memories 510A and 510B and multiple multiplexers 520 instead of memory 320. Memory 510A may output a brightness data signal to AND gates 330 while data is being written to memory 510B. Similarly, memory 510B may output a brightness data signal to AND gates 330 while data is being written to memory 510A. The brightness data signal is selected using multiplexers 520A through 520D based on a value of the select signal. For instance, if select signal is 0 or LO, multiplexer 520A propagates output bo of memory 510A to AND gate 330A, multiplexer 520B propagates output bi of memory 510A to AND gate 330B, multiplexer 520C propagates output b₂ of memory 510A to AND gate 330C, and multiplexer 520D propagates output b₃ of memory 510A to AND gate 330D. If select signal is 1 or HI, multiplexer 520A propagates output bo of memory 510B to AND gate 330A, multiplexer 520B propagates output b₁ of memory 510B to AND gate 330B, multiplexer 520C propagates output b₂ of memory 510B to AND gate 330C, and multiplexer 520D propagates output b₃ of memory 510B to AND gate 330D. Furthermore, an enable signal value of 0 or LO selects memory 510B for writing and an enable signal value of 1 or HI selects memory 510A for writing.

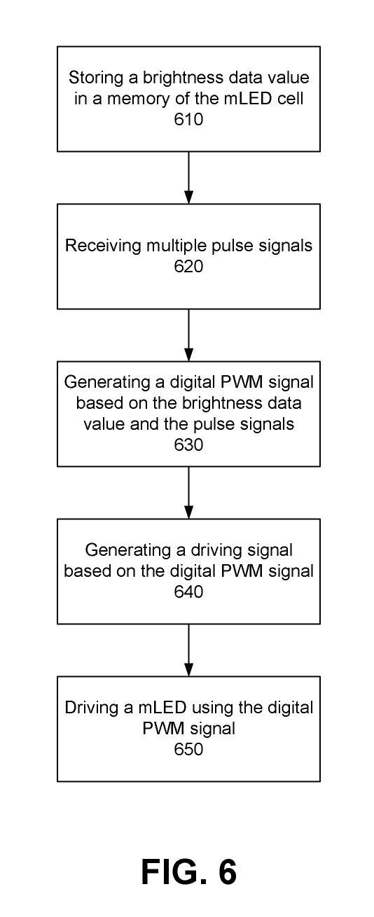

FIG. 6 illustrates a flow diagram of a method for operating a mLED cell, according to one embodiment. The mLED cell 230 receives a brightness data value and stores 610 the brightness data value in memory 320. In some embodiments, the brightness data value is received and stored serially. In other embodiments, the brightness data value is received and stored in parallel. The mLED cell 230 further receives 620 multiple pulse signals. The mLED cell 230 generates 630 a digital PWM signal based on the brightness data value and the multiple pulse signals. The digital PWM is generated by ANDing each bit of the brightness data value with a pulse signal of the multiple received pulse signals.

A driving signal is generated based on the digital PWM signal. In some embodiments, the driving signal is generated by a current source that generates a driving current based on the digital PWM signal. A mLED is driven based on the generated driving signal. The mLED then emits light with an average brightness that is proportional to the brightness data value.

Upon reading this disclosure, those of ordinary skill in the art will appreciate still additional alternative structural and functional designs through the disclosed principles of the embodiments. Thus, while particular embodiments and applications have been illustrated and described, it is to be understood that the embodiments are not limited to the precise construction and components disclosed herein and that various modifications, changes and variations which will be apparent to those skilled in the art may be made in the arrangement, operation and details of the method and apparatus disclosed herein without departing from the spirit and scope as defined in the appended claims.

What is claimed is:

1. A micro light-emitting-diode (mLED) display device comprising:
an mLED configured to emit light; and
a controller receiving a brightness data signal and generating a driving signal corresponding to the brightness data signal, the controller coupled to the mLED for providing the driving signal that turns on the mLED for first times and turns off the mLED for second times for a duration of a cycle, the driving signal causing a current density in mLED to be above a threshold value when the mLED is turned on.

2. The mLED display device of claim 1, further comprising:
a current source coupled between an output of the controller and the mLED to generate a driving current based on the driving signal.

3. The mLED display device of claim 2, wherein the mLED is driven with a current density above 1 A/cm².

4. The mLED display device of claim 2, wherein the controller comprises:
a memory including a plurality of memory cells, the memory further including a plurality of memory outputs, each memory output corresponding to an output of a memory cell, the memory storing the brightness data signal; and
a plurality of gates, each gate of the plurality of gates comprising:
a first input node coupled to a memory output of the plurality of memory outputs,
a second input node coupled to a periodic pulse signal of a plurality of periodic pulse signals, and
an output node, the output node configured to output a signal having a high level when the memory output and the periodic pulse signal have a level higher than a threshold value, and output a signal having a low level when the memory output or the periodic pulse signal have a level lower than the threshold value.

5. The mLED display device of claim 4 wherein the plurality of gates comprises:
a first gate coupled to a first output of the memory and a first periodic pulse signal; and
a second gate coupled to a second output of the memory and a second periodic pulse signal;
wherein the second periodic pulse signal has a pulse duration that is twice as long as a pulse duration of the first periodic pulse signal.

6. The mLED display device of claim 5, wherein a pulse of the second periodic pulse signal starts after an end of a pulse of the first periodic pulse signal.

7. The mLED display device of claim 5, wherein a pulse width of the first periodic pulse signal is inversely proportional to a refresh rate of the mLED cell and a bit-depth of the brightness data signal.

8. The mLED display device of claim of claim 5, further comprising:
a third AND gate coupled to a third output of the memory and a third periodic pulse signal,
wherein the third periodic pulse signal has a pulse duration that is twice as long as the pulse duration of the second pulse signal.

9. The mLED display device of claim 4, wherein the controller further comprises:
a second memory including a plurality of memory cells, the second memory cell further including a plurality second of memory outputs, each output of the plurality of second memory outputs corresponding to an output of a second memory cell; and
a plurality of multiplexers; each multiplexer of the plurality of multiplexers coupled to a memory output and a second memory output;
wherein each of the plurality of gates is coupled to a multiplexer of the plurality of multiplexers.

10. The mLED display device of claim 9, wherein:
the first memory is enabled for writing when the plurality of multiplexers are configured to select the output of the second memory, and
the second memory is enabled for writing when the plurality of multiplexers are configured to select the output of the memory.

11. The mLED display device of claim 4, wherein a number of memory cells of the memory is equal to a bit depth of the brightness data signal.

12. The mLED display device of claim 2, wherein the current source comprises a transistor that is configured to turned on and off based on the output of the controller.

13. A micro light emitting diode (mLED) driver circuit comprising:
a memory including a plurality of memory cells, the memory further including a plurality of memory outputs, each memory output corresponding to an output of a memory cell, the memory storing a value of a brightness data signal; and
a plurality of gates, each gate of the plurality of comprising:
a first input node coupled to a memory output of the plurality of memory outputs,
a second input node coupled to a periodic pulse signal of a plurality of periodic pulse signals, and
an output node, the output node configured to output a signal having a high level when the memory output and the periodic pulse signal have a level larger than a threshold value, and output a signal having a low level when the memory output or the periodic pulse signal have a level smaller than the threshold value; and
a current source, the current source coupled to an output of each of the gates, the current source generating a driving current within a frame based on the outputs of each of the gates, an average amplitude of the driving current based on the brightness data value.

14. The mLED driver circuit of claim 13 wherein the plurality of gates comprises:
a first gate coupled to a first output of the memory and a first periodic pulse signal; and
a second gate coupled to a second output of the memory and a second periodic pulse signal;
wherein the second periodic pulse signal has a pulse duration that is twice as long as a pulse duration of the first periodic pulse signal.

15. The mLED driver circuit of claim 14, wherein a pulse of the second periodic pulse signal starts after an end of a pulse of the first periodic pulse signal.

16. The mLED driver circuit of claim 14, wherein a pulse width of the first periodic pulse signal is inversely proportional to a refresh rate of the mLED driver circuit and a bit-depth of the brightness data signal.

17. The mLED driver circuit of claim 13, further comprising:
a second memory including a plurality of memory cells, the second memory cell further including a plurality second of memory outputs, each output of the plurality of second memory outputs corresponding to an output of a second memory cell; and
a plurality of multiplexers; each multiplexer of the plurality of multiplexers coupled to a memory output and a second memory output;
wherein each of the plurality of gates is coupled to a multiplexer of the plurality of multiplexers.

18. A method for operating a micro light-emitting-diode (mLED), comprising:
generating a driving signal corresponding to brightness data signal;
turning on the mLED for first times in a duration of a cycle by the driving signal to cause a current density in mLED to be above a threshold value; and
turning off the mLED for second times in the duration of the cycle by the driving signal.

19. The method of claim 18, wherein generating the driving signal comprises:
storing the brightness data value in a memory cell of the mLED cell, the brightness data value indicative of a desired brightness for the mLED;
receiving multiple periodic pulse signals, the multiple periodic pulse signals including:
a first periodic pulse signal, and
a second periodic pulse signal, the second pulse signal having a pulse width that is double a pulse width of the first periodic pulse signal;
generating a digital pulse-width-modulation (PWM) signal by ANDing each bit of the brightness data value with a pulse signal of the multiple periodic pulse signals;
generating a driving signal based on the digital PWM signal; and
driving the mLED of the mLED cell using the generated driving signal.

20. The method of claim 19, wherein generating the digital PWM signal comprises:
ANDing the first periodic pulse signal with a least significant bit of the brightness data value; and
ANDing the periodic second pulse signal with a second least significant bit of the brightness data value.
